(19) United States
(12) Patent Application Publication
(10) Pub. No.: US 2003/0154055 A1
(43) Pub. Date: Aug. 14, 2003

(54) System for measurement and display of environmental data

(76) Inventor: Kazuyoshi Yoshimura, Tokyo (JP)

Correspondence Address: David T. Nikaido, RADER, FISHMAN & GRAUER, PLLC, Suite 501, 1233 20th Street, NW, Washington, DC, 20036, US

(21) Appl. No.: 10/067,919

(22) Filed: Feb. 8, 2002

(51) Int. Cl. G06F 11/00; G06F 15/00; G06F 169/00

(52) U.S. Cl. 702/188; 702/3

(57) ABSTRACT

There is disclosed a system for measurement and display of environmental data, permitting a measuring operator other than operators engaged in environmental data-measuring business to measure environmental data with ease for real-time display of the result of measurement on an operator's own client terminal. The system for measurement and display of environmental data makes entry of a value detected by a sensor, which detects environmental data from the surrounding environment to output the detected environmental data, to a client terminal and then transmits data based on the detected value from the client terminal to a server terminal. Then, the server terminal produces, on the basis of the transmitted data, environmental data capable of being displayed on the client terminal to transmit the environmental data to the client terminal, and the client terminal receives the environmental data from the server terminal to graphically display the environmental data with a display means of the client terminal.

### BACKGROUND OF THE INVENTION

1. Field of the Invention

This invention relates to a system for measurement and display of environmental data, and more specifically, to a system, which allows the result of measurement on environmental data to be displayed on a client terminal, using a portable telephone, a portable information device and a computer or the like as the client terminal.

2. Description of the Prior Art

Recently, an interest in the environment inclusive of the weather, a tendency toward warmer climate or the enlargement of ozone holes, the acid rain and the noise or the like has been increasing. It is ordinary to check up on how is environmental data such as values or the like of ultraviolet radiation, atmospheric temperature, humidity, atmospheric pressure, smell, CO₂ concentration, pH and noise or the like by the weather forecast or the like, before deciding to carry or wear a coat to outdoors when the atmospheric temperature is forecasted to be low, or deciding to put on anti-ultraviolet makeup before going out of doors when the ultraviolet radiation is forecasted to be high, and so on.

However, the above environmental data is dependent on data issued from the weather forecast or the like at present. For that reason, real-time environmental data in a place where a measuring operator who wants to know environmental data is at present or at one's destination is not always provided.

Although a measuring device is required for the measuring operator oneself to measure the above environmental data, any measuring device easily handy to carry to outdoors does not exist yet.

Accordingly, the measuring operator other than operators engaged in environmental data-measuring business fails to easily make sure of a change or the like of environmental data.

### SUMMARY OF THE INVENTION

It is an object of the present invention to provide a system for measurement and display of environmental data, permitting an environmental data-measuring operator to easily measure the environmental data for making sure of the result of measurement.

For attaining the above object, the present invention has the following features.

Firstly, a system for measurement and display of environmental data according to the present invention comprises a client terminal allowing entry of a value detected by a sensor, which detects environmental data from the surrounding environment to output the detected environmental data, and a server terminal capable of data communication with the client terminal through a data communication network, wherein the client terminal has a data transmission means capable of transmitting data based on the value detected by the sensor to the server terminal, the server terminal has an operation means for producing, on the basis of the data transmitted from the client terminal, environmental data capable of being displayed on the client terminal and a transmission means for transmitting the environmental data to the client terminal, and the client terminal receives the environmental data from the server terminal and is also provided with a display means allowing display of the environmental data.

Secondly, the system for measurement and display of environmental data according to the present invention is characterized in that the data communication network includes a communication line network including either or both of internet and LAN (Local Area Network) line.

Thirdly, the system for measurement and display of environmental data according to the present invention is characterized in that the display means has a display and a web browser, the transmission means has a HTTP server operational on the server terminal, and the environmental data includes data capable of being transmitted by the HTTP server and also being displayed by the web browser.

Fourthly, the system for measurement and display of environmental data according to the present invention is characterized in that the environmental data includes data allowing graphics to be displayed on the client terminal, and the display of the client terminal includes a display capable of graphic display.

Fifthly, the system for measurement and display of environmental data according to the present invention is characterized in that the client terminal includes a portable telephone, a portable information device or a personal computer.

Sixthly, the system for measurement and display of environmental data according to the present invention is characterized in that the sensor includes an open-air state measuring sensor or a sensor for measuring the state of a contact part being in contact with the sensor.

Seventhly, the system for measurement and display of environmental data according to the present invention is characterized in that the server terminal has a data base server for storing the data transmitted from the client terminal, and the operation means allows execution of environmental data operation on the basis of the data in the data base server.

### BRIEF DESCRIPTION OF THE DRAWINGS

The foregoing and other objects and features of the invention will become apparent from the following description of preferred embodiments of the invention with reference to the accompanying drawings, in which:

FIG. 1 illustrates a model of a system for measurement and display of environmental data according to the present invention;

FIG. 2 is a schematic illustration of a portable telephone according to the present invention;

FIG. 3 is a block diagram showing functions of the portable telephone according to the present invention;

FIG. 4 is a block diagram showing functions of a server computer according to the present invention;

FIG. 5 illustrates the external appearance of a note-type personal computer serving as a client terminal according to the present invention; and

FIG. 6 illustrates the external appearance of a portable information device serving as the client terminal according to the present invention.

### DETAILED DESCRIPTION OF THE PREFERRED EMBODIMENTS

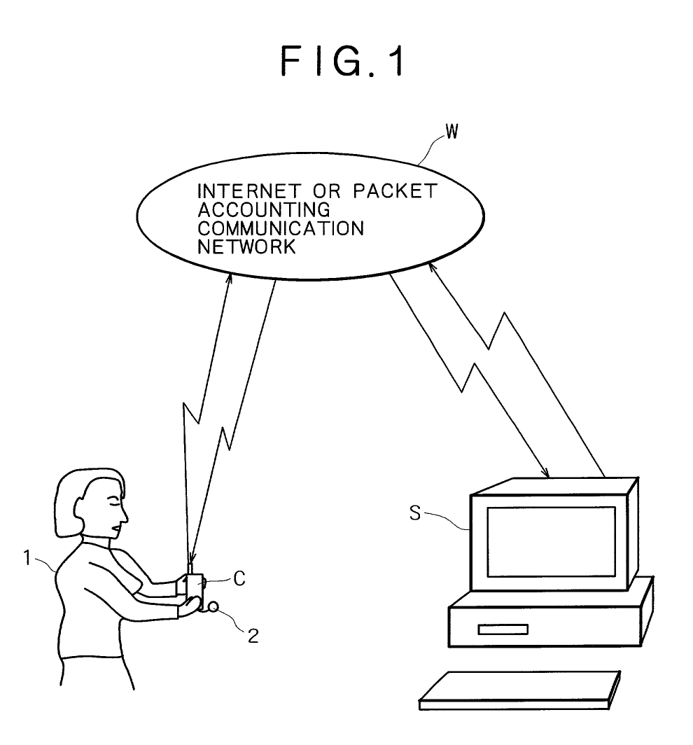

FIG. 1 illustrates a model of a system for measurement and display of environmental data according to the present invention. This system permits a measuring operator 1 to measure environmental data such as values of ultraviolet radiation, atmospheric temperature, humidity, atmospheric pressure, smell, CO₂ (carbon dioxide) concentration, pH (potential of hydrogen) and noise with a sensor 2 for transmitting the result of measurement from a client terminal C to a server terminal S through a computer-communicable data communication network W.

The server terminal S transmits data representing the result of measurement to the client terminal C to allow the result of measurement to be graphically displayed on the client terminal C, whereby the measuring operator 1 may make sure of the environmental state through display on the client terminal C.

In the present embodiment, a portable telephone is used as the client terminal C, a general-purpose server computer is as the server terminal S, and internet or packet accounting communication network serving as LAN line requiring accounting depending on the packet traffic is as the data communication network W.

Thus, specifically, measured data on the predetermined environment is transmitted from the portable telephone to the server computer through the internet or packet accounting communication network. The server computer makes analysis of the measured data transmitted from the portable telephone to produce, on the basis of the measured data, environmental data capable of being displayed on the portable telephone, and then transmits the environmental data to the portable telephone through the internet or packet accounting communication network. The portable telephone 3 receives the environmental data from the server computer to display the environmental data. Accordingly, the measuring operator may obtain measured environmental state information in approximately real time by reading the environmental data displayed on the portable telephone.

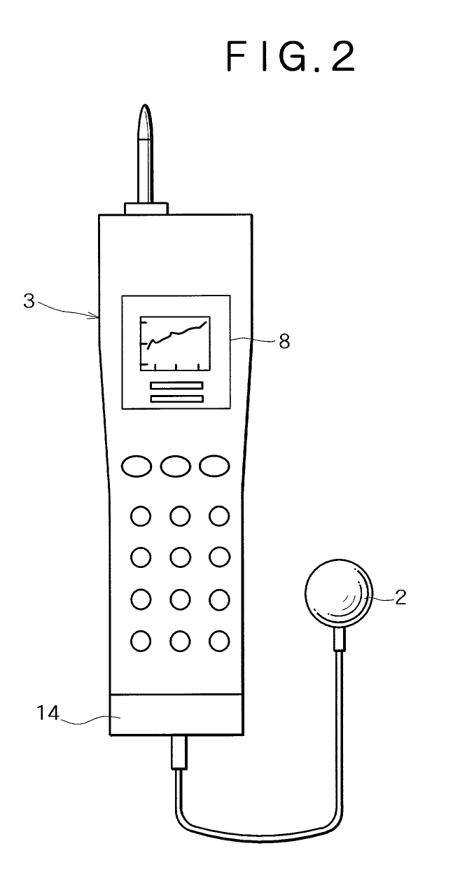

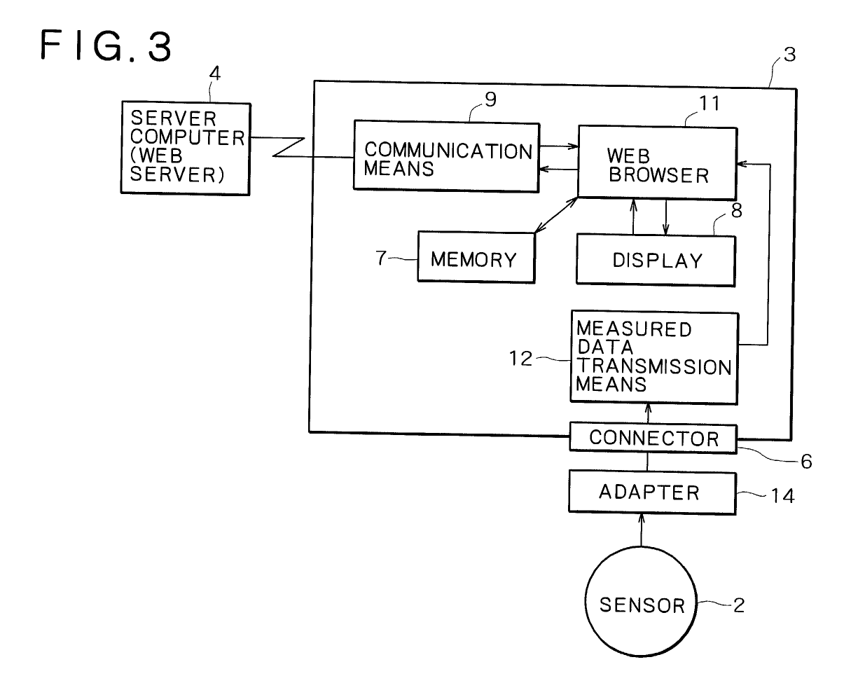

As shown in FIGS. 2 and 3, the portable telephone 3 is capable of data communication with a computer or the like other than normal telephone speech, and has a connector 6 for connection to a personal computer or the like, a memory 7 for storage of a telephone number or the like, a display 8 capable of graphic display and so on.

The portable telephone 3 also has a communication means 9 capable of communication with a web server of the server computer 4 through communication protocol including TCP/IP and HTTP, a web browser 11 and a measured data transmission means 12.

The web browser 11 receives data from the web server of the server computer 4 through the communication means 9 to display the received data on the display 8, and also transmits data to the web server through the communication means 9.

The measured data transmission means 12 transmits the measured data supplied from the sensor 2 through the connector 6 to the web server through the web browser 11.

The target environment for measurement includes the open air environment such as ultraviolet radiation, atmospheric temperature, humidity, offensive smell, atmospheric pressure, noise and CO₂ concentration and the environment in a predetermined place such as pH value in a predetermined part and water content value in predetermined soil and so on.

The sensor 2 for measurement of environmental data is supposed to be a ultraviolet sensor, a temperature sensor, a humidity sensor, a smell sensor, an atmospheric pressure sensor, a CO₂ sensor, a noise sensor, a pH sensor and a water content sensor or the like.

An adapter 14 allowing entry of a detected value outputted from the sensor 2 to the measured data transmission means 12 through the connector 6 is mounted to the sensor 2.

Output from the sensor 2 is transmitted to the web server of the server computer 4 with the portable telephone 3, after being sent to the measured data transmission means 12 with the adapter 14 mounted to the connector 6 of the portable telephone 3.

The adapter 14 has an I/V converting part, an A/D converting part or the like matching up to the sensor 2 to amplify an output signal from the sensor 2 for conversion into measured data enough to be recognized by the measured data transmission means 12.

When there is a need for the measuring operator 1 to take the current atmospheric temperature around the measuring operator 1 oneself, for instance, the measuring operator 1 sets up the sensor 2 to the connector 6 of the portable telephone 3 through the adapter 14, before starting communication between the portable telephone 3 and the server computer 4 to display a web page transmitted from the web server on the display 8 of the portable telephone 3.

Under the above state, the measuring operator 1 sends the measured data obtained by the sensor 2 to the web server using the web page on the display 8. Thereby, the server computer 4 conducts the processing on the received measured data to display current atmospheric temperature data on the display 8 of the portable telephone 3.

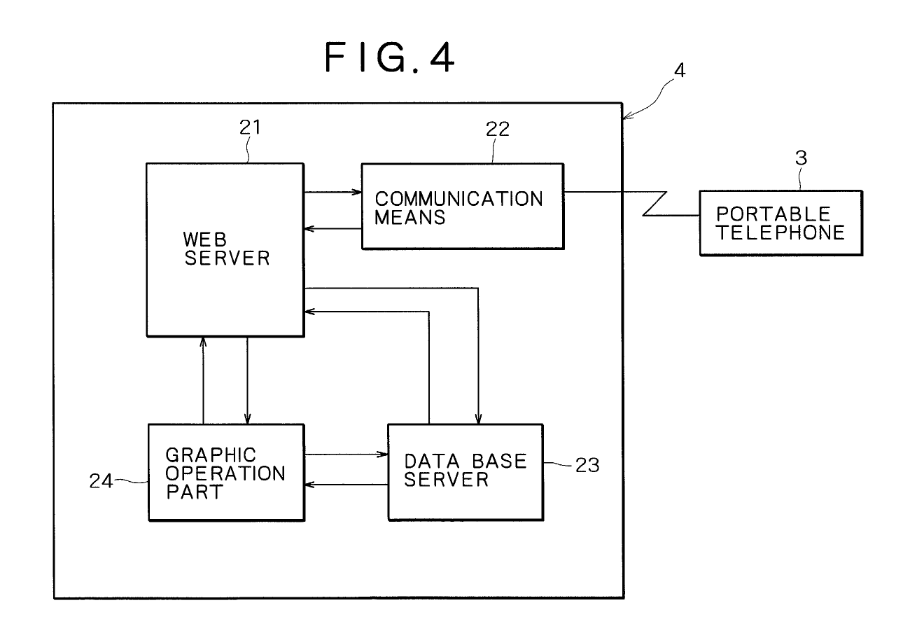

As shown in FIG. 4, the server computer 4 has a web server 21, a communication means 22 for communication of the web server 21 with the portable telephone 3, a data base server 23 for storing the measured data supplied to the web server 21, a graphic operation part 24 allowing the web browser 11 to display a graphic screen such as environmental information graph and so on.

The graphic operation part 24 may produce graphically displayed graphic data in the web browser 11 on the display 8 of the portable telephone 3 on the basis of the real-time measured data supplied to the web server 21 or the past measured data stored in the data base server 23.

The graphic data produced by the graphic operation part 24 is stored in the data base server 23.

The web server 21 has a well-known HTTP server operational on the server computer 4, and may receive data from the web browser 11 serving as a HTTP client and also may transmit data written in chtml or like language to the HTTP client 11 through the communication means 22.

A description will now be specifically given of the operation of the server computer. When portable telephone access to the web server 21 is detected, the server computer 4 sends data, which allows display of the web page, to the portable telephone 3 to display the web page on the portable telephone 3.

The web page has a graph display screen for display of graphs or the like represented on the basis of graphic data and an instruction screen for instructions to transmit at least the measured data or to display the past measured data in a graphic form. The portable telephone 3 allows display of the graph display screen and the instruction screen selectively through switching operation or display of both the screens simultaneously.

However, when the portable telephone 3 has first access to the server computer 4, the instruction screen appears on the portable telephone 3 without transmission of any graphic data from the web server 21 to the portable telephone 3. This is for the reason that the instructions to transmit the measured data and to display graphics based on the past measured data are issued only through the instruction screen, and therefore, it is considered that the measured data has not been transmitted yet or the instruction to display graphics based on the past measured data has not been issued yet when first access is granted.

A description will now be given of the case that there is a need for the measuring operator 1 to take the current real-time atmospheric temperature. The measuring operator 1 sends measured data from the temperature sensor 2 to the web server 21 of the server computer 4 through execution of a measured data transmission button or the like on the web page according to the instructions on the instruction screen of the web page.

The measured data from the sensor 2 and data representing real-time display are supplied to the web server 21 through the web browser 11, and the server computer 4 transmits the measured data to the data base server 23 and the graphic operation part 24. The data base server 23 stores the measured data in the data base, and the graphic operation part 24 transforms the measured data into graphic data.

The server computer 4 transmits the graphic data to the web server 21, and the graphic data is transmitted from the web server 21 to the portable telephone 3. When the portable telephone 3 receives the graphic data from the web server 21, the graphic data is displayed in a graphic form on the display 8 by the web browser 11, whereby the measuring operator 1 may ascertain the real-time atmospheric temperature graphically.

When the measuring operator 1 transmits information representing a required past atmospheric temperature data period to the web server 21 through execution of the transmission button or the like on the web page according to the instruction screen of the web page, graphics based on the past measured atmospheric temperature data may be displayed on the portable telephone 3.

The system described the above permits measurement on the environmental state around the measuring operator 1 oneself with ease to display the measured data on the portable telephone 3, and therefore, the measuring operator 1 may get the environmental data by carrying the portable telephone 3 and the environment measuring sensor 2 without the need for a special measuring device. Then, the measured environmental data is also easily applicable to personal use such as a change in how to put on makeup depending on the environmental data, for instance.

Since the measuring operator 1 does not need to be engaged in environmental data measuring business by reason that the server computer 4 performs operations for analysis of the environmental data such as operation of the measured values and conversion into display format, no special knowledge on measurement of the environmental data is required for the measuring operator 1.

Further, an arithmetic device or the like becomes useless for the portable telephone 3, and the portable telephone 3 eliminates the need for a large number of hardware resources, resulting in a reduction in load on the client terminal C. Furthermore, displayed data on the portable telephone 3 may be updated by updating the software on the server computer 4.

The measurement history is stored in the server computer 4, and as a result, a storage device or the like larger in size than needed is not required for the portable telephone 3 to store the measurement history or the like. Thus, the graphics based on the measurement history stored in the data base server 23 may be easily displayed on the portable telephone 3, and display of time-series environmental transition or the like is also possible with ease.

Since the web service allows data communication between the portable telephone 3 and the server computer 4, any terminal like the portable telephone 3 mounted with the general HTTP client such as the web browser 11 is available for the client terminal C. The client terminal C eliminates the need for special client functions dedicated to the present system, and as a result, the present system may be operated with more ease.

Output from the sensor 2 is converted into the measured data in an abstract form with the adapter 14 on the portable telephone 3, permitting measurement on various environmental information by matching the adapter 14 up to each sensor without applying high load to the portable telephone 3.

It may be also configured to write a program in the portable telephone 3 in advance for assigning partial or whole functions of the measured data processing like the graphic operation part 24, for instance, to the portable telephone 3. In this case, the result of operation may be displayed at higher speed by allowing the data base server 23 of the server computer 4 to store the measured data, for instance.

However, in addition to a relatively large storage capacity, the program execution environment is separately required for the portable telephone 3 at need. Incidentally, the program execution environment may be also assigned to the web browser 11 by writing the above program in Java.

Having described the embodiment with the internet or packet accounting communication network (LAN line) as the data communication network, it is to be understood that both of the internet and packet accounting communication network are also available by applying the packet accounting network to connection to the internet and so on, for instance.

Since accounting is required for the packet accounting communication network depending on packet traffic, there is no need for accounting for a period of non-communication between the client terminal C and the server terminal S even if connected for a long period of time, resulting in no increase in communication fee more than needed.

Having described the embodiment with the structure that the sensor 2 is connected to the outside of the portable telephone 3, it is to be understood that the sensor 2 may be also incorporated in a frame body of the portable telephone 3 as one body. For instance, using a plurality of ultraviolet sensors (photo-diodes) provided in the portable telephone 3 for efficient sensing of ultraviolet rays permits the measuring operator 1 to measure the ultraviolet intensity distribution in a light sensing area with ease by setting the sensor mounting face serving as the light sensing face of the portable telephone 3 to receive ultraviolet radiation as perpendicularly as possible.

The sensor mounted to the portable telephone 3 may be a temperature sensor, a humidity sensor or the like. Otherwise, a plurality of different kinds of sensors may be also mounted to the portable telephone.

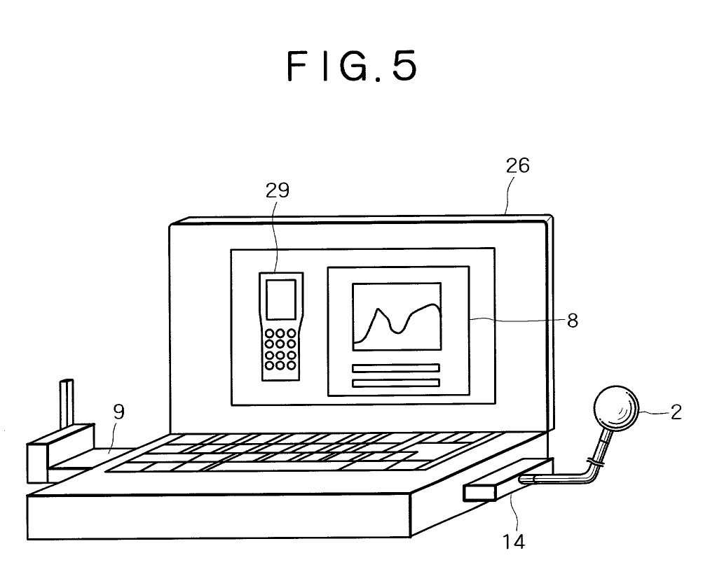

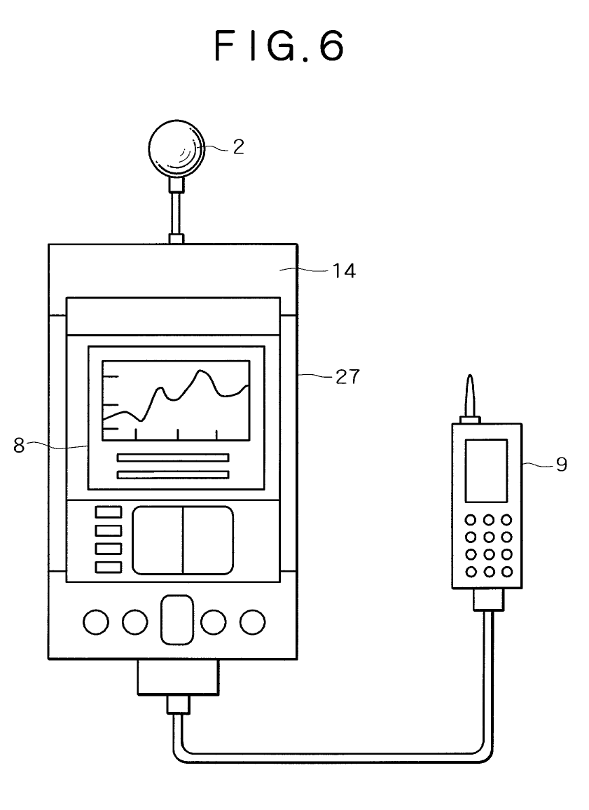

Having described the embodiment with the portable telephone 3 as the client terminal C, it is to be understood that a note-type personal computer 26, a portable information device (PDA) 27 or the like may be also used as the client terminal C, as shown in FIGS. 5 and 6.

When the note-type personal computer 26 is used as the client terminal C, the communication means 9, which is in communication with the server computer 4, and the sensor 2 may be connected to the note-type personal computer 26 via a PC card throttle as shown in FIG. 5. The external device such as a communication card and the sensor 2 may be easily connected to the client terminal C.

When the sensor 2 is connected to the note-type personal computer 26 via the PC card throttle, the adapter 14 should be of a PC card type, and the note-type personal computer 26 also needs power enough to send output from the sensor 2 to the PC card throttle with the communication means 9 inserted.

When I/O interface such as serial port and parallel port is applied to the interface of the sensor 2, the adapter 6 matching up to either of the ports is required.

With the above configuration, activating the web browser mounted to the note-type personal computer 26 permits communication with the server computer 4 for measurement on the environment data similarly to the case that the portable telephone 3 is in use.

It may be also configured to simulate the portable telephone 3 on the client terminal C for measurement on the environmental data with a simulated portable telephone 29.

Java or the like may be used to simulate the portable telephone with ease. Simulation of the portable telephone 3 on the web browser 11 with data from the web server 21 or data downloaded in advance from the web server 21 permits measurement on the environmental data as described the above, irrespectively of OS and platform of the note-type personal computer 26.

An increase in processing speed or the like is also made possible by assigning partial or whole functions of the graphic operation part 24 or the like to the client terminal C.

As shown in FIG. 6, a PDA 27 is also available for the client terminal C. Using the PDA 27 also permits measurement on the environmental data with ease similarly to the case that the note-type personal computer 26 is used as the client terminal C. However, when I/O for connection of the sensor 2 is other than the PC card throttle or the like based on the predetermined standards, the adapter 14 matching up to the PDA 27 is required.

Using the PDA 27 capable of connection to the portable telephone 3 permits the portable telephone to serve as a communication device 9 for communication with the server computer 4 by connecting the portable telephone to the PDA 27.

With the above configuration, activating the web browser 11 mounted to the PDA permits communication with the server computer 4 for measurement and display of the environment data with ease.

What is claimed is:

1. A system for measurement and display of environmental data, comprising:
a client terminal allowing entry of a value detected by a sensor, which detects environmental data from the surrounding environment to output the detected environmental data; and
a server terminal capable of data communication with the client terminal through a data communication network:
wherein said client terminal has a data transmission means capable of transmitting data based on the value detected by the sensor to the server terminal;
said server terminal has an operation means for producing, on the basis of data transmitted from the client terminal, environmental data capable of being displayed on the client terminal, and a transmission means for transmitting the environmental data to the client terminal; and
said client terminal receives the environmental data from the server terminal and is also provided with a display means allowing display of the environmental data.

2. A system for measurement and display of environmental data according to claim 1, wherein said data communication network includes a communication line network including either or both of internet and LAN line.

3. A system for measurement and display of environmental data according to claim 2, wherein said display means has a display and a web browser, said transmission means has a HTTP server operational on the server terminal, and said environmental data includes data capable of being transmitted by the HTTP server and also being displayed by the web browser.

4. A system for measurement and display of environmental data according to claim 3, wherein said environmental data includes data allowing graphics to be displayed on the client terminal, and said display of the client terminal includes a display capable of graphic display.

5. A system for measurement and display of environmental data according to claim 4, wherein said client terminal includes a portable telephone, a portable information device or a personal computer.

6. A system for measurement and display of environmental data according to claim 5, wherein said sensor includes an open air state measuring sensor or a sensor for measuring the state of a contact part being in contact with the sensor.

7. A system for measurement and display of environmental data according to claim 6, wherein said server terminal has a data base server for storing data transmitted from the client terminal, and the operation means allows execution of environmental data operation on the basis of the data in the data base server.
